(19) United States
(12) Patent Application Publication
(10) Pub. No.: US 2025/0013879 A1
(43) Pub. Date: Jan. 9, 2025

(54) DECISION OPTIMIZATION INVOLVING GLOBAL OBJECTIVES AND GLOBAL CONSTRAINTS

(71) Applicant: Salesforce, Inc., San Francisco, CA (US)

(72) Inventors: Alex RICH, San Francisco, CA (US); Stefan EBERL, San Francisco, CA (US); Vaastav ARORA, San Francisco, CA (US)

(21) Appl. No.: 18/219,186

(22) Filed: Jul. 7, 2023

(51) Int. Cl. G06N 5/01

(52) U.S. Cl. CPC G06N 5/01

(57) ABSTRACT

A computer-implemented method of decision optimization in a multi-record environment is disclosed. The method includes receiving a request to make a recommendation in relation to a data record and defining the recommendation in terms of an optimization problem including decision objectives including objective contribution functions and constraints including constraint contribution functions. The method also includes extracting input data from a data source, the input data including individual instances of data and attributes describing the individual instances of data. The method also includes identifying a context of the optimization problem based upon the individual instances of data. The context relates to a behavior of the input data given the decision objectives and the constraints. The method further includes solving the optimization problem by satisfying the decision objectives and the constraints, in the context, to generate a solution and providing the recommendation based on the solution.

### BACKGROUND

The present disclosure relates generally to optimization techniques, and more particularly, to a computer implemented method and system for providing an optimal solution in a multi-record environment. Existing optimization platforms typically consume lot of data to build predictive models that deliver predictions and recommendations scoped in relation to singular records. That is an underutilization of organizational resources and there is a need to prioritize the resources so that multi-record predictions and recommendations, aggregated at the level of the organization, are obtained from the predictive models. Further, existing optimization problems assume the input data to be static and use mathematical techniques to arrive at an optimal solution based on the static data. In reality, however, actual input data may often be dynamic and change with time. As a result, enhanced optimization techniques are needed that would process dynamic data and deliver optimization solutions in real time with high accuracy.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1A is a block diagram illustrating an example system for decision optimization involving global objectives and global constraints.

FIG. 1B is a visual representation of an Abstract Syntax Tree structure of an example optimization function.

FIG. 1C is a visual representation of an Abstract Syntax Tree structure of an example optimization function.

FIG. 1D is a first visual representation of an Abstract Syntax Tree structure of an example optimization function.

FIG. 1E is a second visual representation of an Abstract Syntax Tree structure of the optimization function of FIG. 1D.

FIG. 1F is a first visual representation of a simplified Abstract Syntax Tree structure of an example optimization function.

FIG. 1G is a second visual representation of a simplified Abstract Syntax Tree structure of the optimization function of FIG. 1F.

FIG. 1H is a third visual representation of a simplified Abstract Syntax Tree structure of the optimization function of FIG. 1F.

FIG. 2A is a flow diagram illustrating a method for generating automated marketing promotions of the system of FIG. 1A.

FIG. 2B is a flow diagram illustrating a method for generating automated marketing promotions of the system of FIG. 1A.

FIG. 3A is a block diagram illustrating an exemplary electronic device according to an example implementation.

FIG. 3B is a block diagram of an exemplary deployment environment according to an example implementation.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Various implementations of the disclosed subject matter relate generally to and may provide improvements to apparatus, systems, and methods allowing an organization to reach a decision optimization solution in a multi-record environment. More particularly, the apparatus, systems and methods allow organizations to utilize organizational resources and to prioritize these resources so that multi-record predictions and recommendations, aggregated at the level of the organization, are obtained from the predictive models. Further, the apparatus, systems and methods allow organizations to optimize their decisions based on data that are both static and dynamic. The result is an improved solution for the whole organization, given its multitude of system-level decision objectives and decision constraints.

Embodiments of the present disclosure provide for defining an optimization problem as a metamodel. The metamodel describes a number of decision objectives and a number of optimization constraints. An optimization solver may be selected from a number of different solvers based on the optimization constraints and the input data. A dynamic context, relating to the input data, is injected into the definition of the optimization problem. An abstract syntax tree (AST) structure conforming to a corresponding formula grammar includes references to the dynamic context and the dynamic context populates the AST. The optimization solver traverses the context, solves the optimization problem satisfying the decision objectives and the optimization constraints, and provides optimized solutions. The optimized solutions are stored to be accessed directly in real time or at a different time during a solution consumption stage.

In an aspect of the disclosed subject matter, a computer-implemented method is disclosed for decision optimization in a multi-record environment. The computer-implemented method may include receiving a request to make a recommendation in relation to a data record and defining the recommendation in terms of an optimization problem that includes a number of decision objectives including objective contribution functions and a number of constraints including constraint contribution functions. The computer-implemented method also includes extracting input data from a data source, the input data including a number of individual instances of data and attributes describing the individual instances of data. The computer-implemented method also includes identifying a context of the optimization problem based upon the individual instances of data. The context relates to a behavior of the input data given the decision objectives and the constraints. The computer-implemented method further includes solving the optimization problem by satisfying the decision objectives and the constraints, in the context, to generate a solution and providing the recommendation based on the solution.

The input data includes dynamic data with a dynamic context, the dynamic context having a nonpredetermined behavior. An abstract syntax tree (AST) structure conforming to a corresponding formula grammar includes references to dynamic contexts and the dynamic context populates the AST. A performance of the abstract syntax tree structure is optimized using an optimization strategy based on a mathematical formula of the abstract syntax tree structure.

Satisfying the plurality of constraints may include applying the respective constraint contribution functions to the input data, aggregating the constraint contribution functions to an aggregated constraint contribution value, and comparing the aggregated constraint contribution value to a pre-specified constraint contribution limit value.

The extracting the input data includes fetching the input data from the data source, arranging the input data in a canonical data structure, and providing the input data, arranged in the canonical data structure, to an optimization solver, wherein the optimization problem is solved by the optimization solver. The input data and the optimization solver are independent of each other. Further, the optimization solver optimizes the objective contribution functions and the constraint contribution functions using an iterative approach based on metaheuristics of the optimization solver.

The computer-implemented method may further include storing the solution, wherein the solution is accessed directly in real time or at a different time during a solution consumption stage.

The computer-implemented method may further include pairing the solution to a corresponding individual instance of data and applying the solution to the corresponding individual instance of data.

The computer-implemented method may further include providing the composite promotion payload to a user interface for display to the user as the marketing promotion requested by the user. The marketing promotion generated by the API platform includes a promotion directed to the target information, the qualifier information and the discount information.

In an aspect of the disclosed subject matter, a system is disclosed for decision optimization in a multi-record environment. The system may include one or more computer processors and a server application digitally connected with the computer processors. The server application may include a decision optimization model configured to receive a request to make a recommendation and generate a recommendation based on the request. The system may also include a non-transitory machine-readable storage medium that provides instructions that are configurable to cause the system to perform any of the methods disclosed herein.

In an aspect of the disclosed subject matter, a non-transitory machine-readable storage medium is disclosed that includes instructions that, if executed by a processor, are configurable to cause said processor to perform operations and methods for generating a marketing promotion.

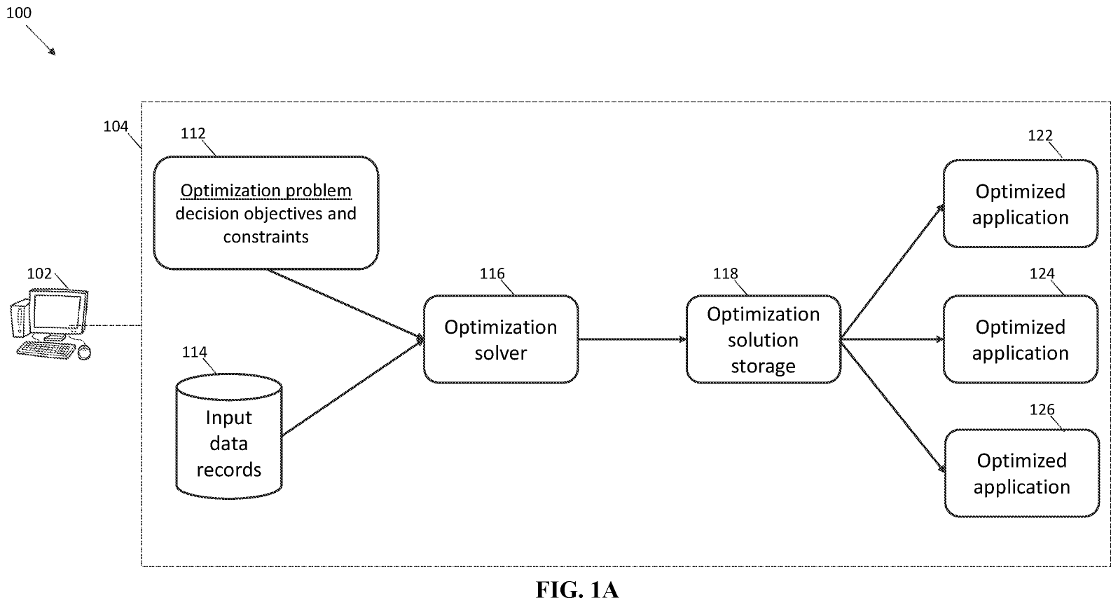

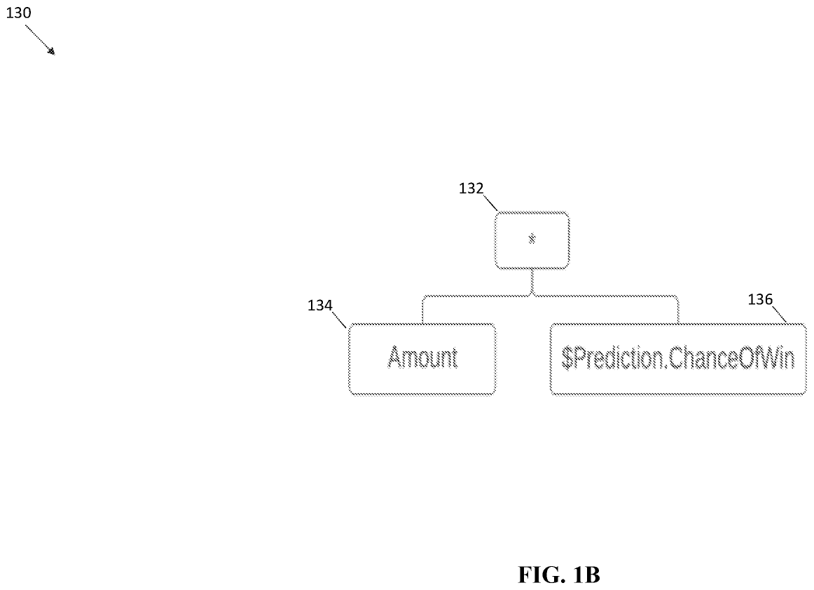

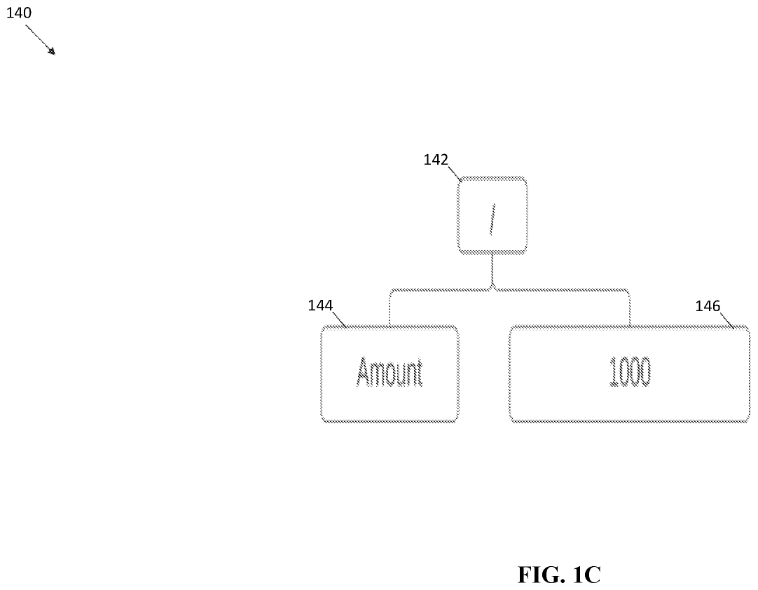

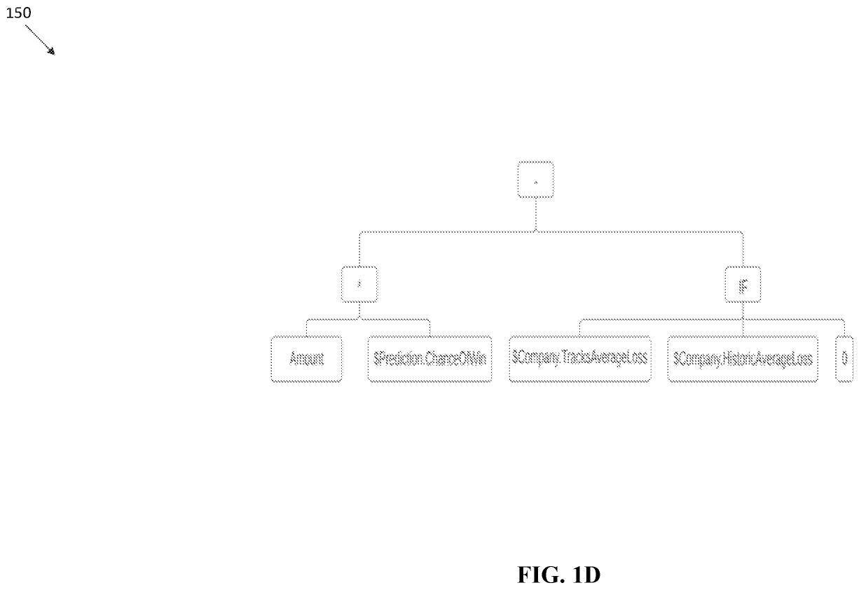

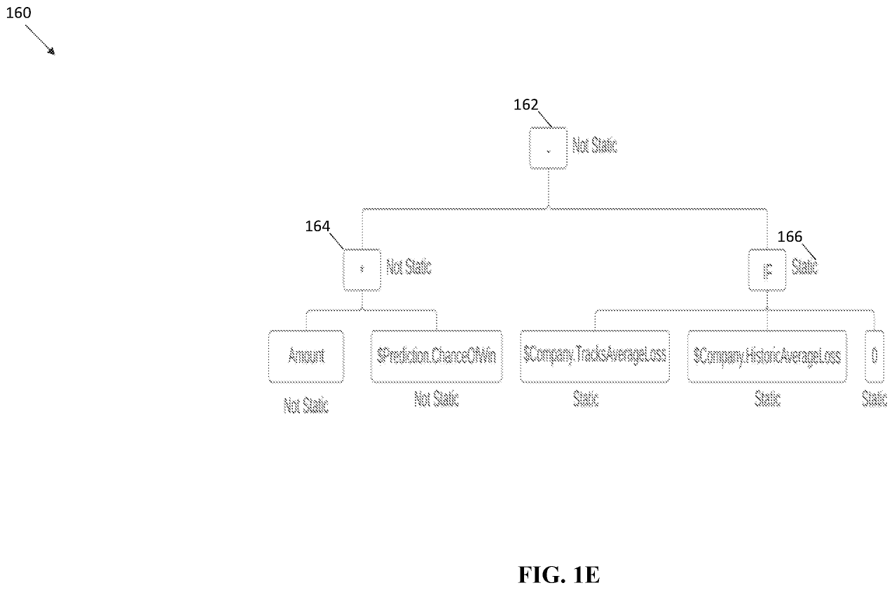

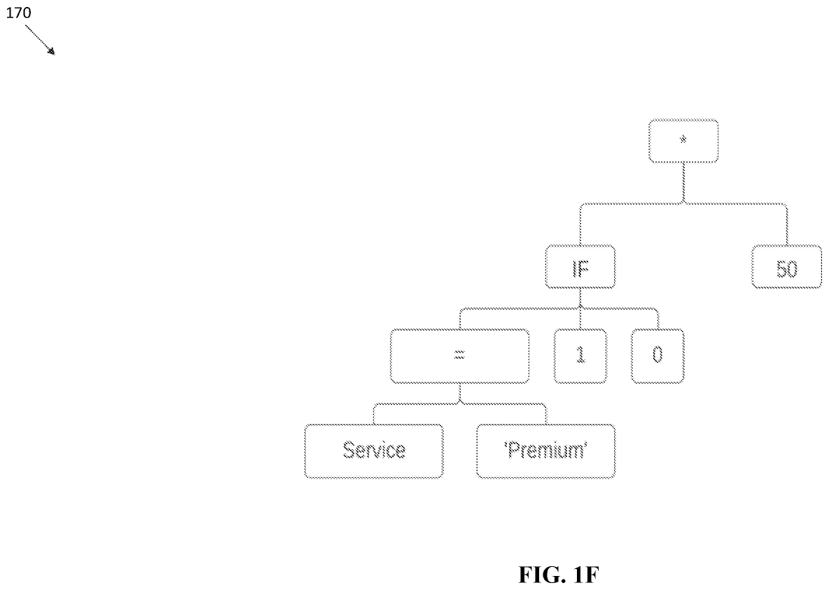

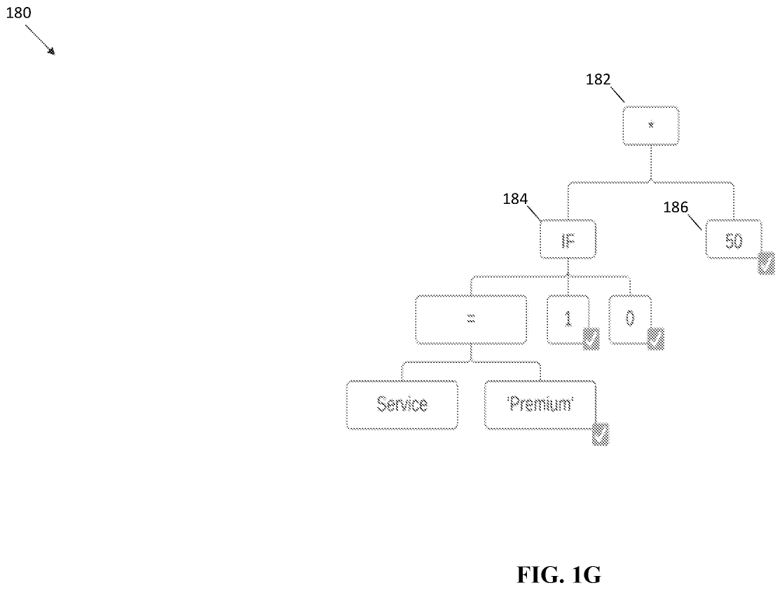

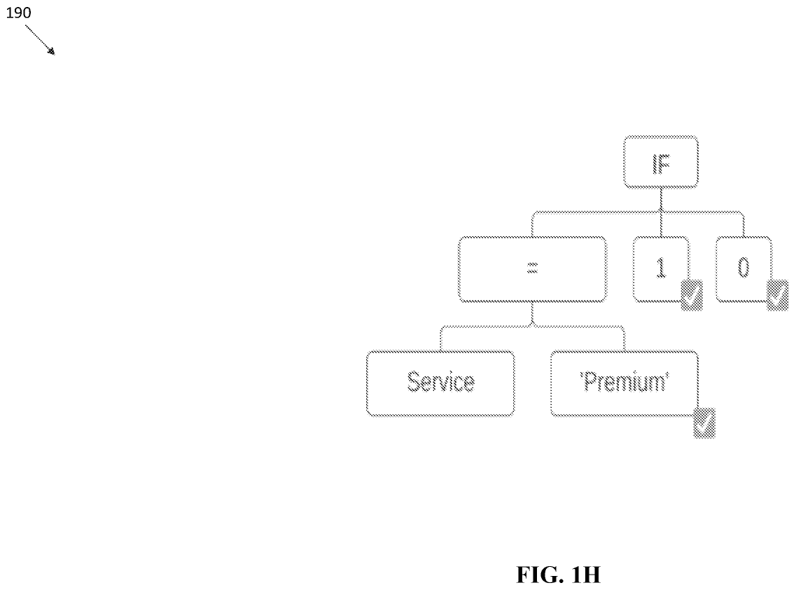

FIG. 1A is a block diagram illustrating an example system 100 for decision optimization involving decision objectives and decision constraints. The system 100 may include one or more computer processors 102 and a server application 104 that is digitally connected with the computer processors 102. The server application 104 may include a decision optimization model (also referred to as “metamodel”) 112 that may receive and process a request to make recommendations in relation to data stored and managed in a multi-record environment such as a business organization, also referred to as a “tenant”. The decision optimization model 112 may be defined in terms of a number of decision objectives (also referred to as “objectives”) and decision constraints (also referred to as “constraints”). The decision objectives may, in turn, be defined or formulated in terms of corresponding objective contribution functions. In a similar manner, the constraints may be defined or formulated in terms of corresponding constraint contribution functions. The objective contribution functions and the constraint contribution functions are explained in more details below.

In order to achieve the recommendation goals, the decision optimization model 112 may identify and differentiate closed and open opportunities, relating to the tenant, for optimization. Closed opportunities refer to solutions that cannot be improved further, while open opportunities refer to solutions that can be improved by adjusting corresponding inputs. In mathematical optimization, a solution is considered closed if it satisfies all the constraints and cannot be improved further in terms of the objective function. On the other hand, an open opportunity is a solution that can be improved by adjusting the inputs. These solutions are not considered optimal, and further analysis and optimization is required to find a better solution. In some cases, an open opportunity may be considered a starting point for further optimization, where the objective and constraints are adjusted to find a better solution. Embodiments disclosed herein may identify, calculate, and implement solutions to such optimization problems. As used herein, an “optimal” solution or a solution to an optimization problem may be one that is more optimized than an approach that would be implemented by the system in the absence of the identification and solution of the optimization problem. An “optimal” solution may be more optimal than other solutions, but may not be the “most optimal” solution that is mathematically available. For example, systems and techniques disclosed herein may identify a solution that is sufficiently optimal to be achievable in an acceptable processing time, or using an acceptable amount of processing resources, where more optimized solutions may require unacceptable use of computing resources.

The decision optimization model 112 may identify both closed and open opportunities and this information may be used to guide the optimization process and determine the best solutions. By considering both closed and open opportunities, the optimization process may be made more efficient and accurate, leading to better solutions that meet the objectives and constraints.

Referring to FIG. 1A, decision optimization model 112 may extract the multi-record input data stored in a database of input records 114. The database of input records 114 may include a number of individual instances of data and a number of attributes describing the individual instances of data. Further, there may be a “context” identified for the optimization problem based upon the individual instances of data. As is commonly known in decision optimization art, a “context” relates to and describes a behavior of the input data given the decision objectives and the constraints.

The database of input records 114 may include both static and dynamic data. Static data refers to information that is constant and does not change during the optimization process. For example, the weight of an object is a piece of static data because it does not change during the optimization process. Static data may include values such as the number of components in a system, the dimensions of an object, or the properties of materials.

Dynamic data refers to information that may change during an optimization process and/or over time. This type of data may be influenced by various factors such as external inputs, user interactions, or real-time updates. For example, the temperature of a system is a piece of dynamic data because it may change during the optimization process. For example, a user may not have all necessary information available at the time of defining an optimization problem. The user, in that case, may incorporate the unavailable data into the problem definition as dynamic data and the dynamic data may be resolved in the context of that optimization process later on, multiple times, over multiple scenarios, for multiple tenants.

Both static and dynamic data may contribute in determining an optimal solution. Static data provides the foundation for the optimization problem, while dynamic data represents the changing conditions that may affect the solution. By considering both static and dynamic data, the optimization process may be more accurate and effective, leading to better solutions that meet the objectives and constraints.

In an instance, the dynamic data may relate to a dynamic context, which is one that has a nonpredetermined behavior. An abstract syntax tree (AST) structure conforming to a corresponding formula grammar includes references to dynamic contexts with which the AST may be populated.

As is commonly known, an abstract syntax tree (AST) is a tree-like data structure that represents the structure of a mathematical expression or formula. An AST is a way to represent the syntax and structure of a formula in a compact and easily manipulable form. In an AST, the formula is represented as a tree of nodes, where each node represents an operator, function, or variable in the formula. The structure of the tree represents the order of operations and the relationships between the different components of the formula. In optimization scenarios, ASTs may be used to represent the objective function or constraints in a problem. By using an AST, the formula may be easily manipulated and optimized, as the tree structure allows for efficient evaluation and manipulation of the formula.

A contextual formula grammar is a set of rules that define the syntax and structure of a mathematical formula. It specifies the valid combinations of variables, constants, operators, and functions that may be used in a formula. Formula grammars are used to validate formulas and to generate ASTs. ASTs and formula grammars are closely related in decision optimization because the AST is the data structure that is generated from a formula that conforms to a particular formula grammar. Further, the formula grammar specifies the valid structure of a formula, and the AST represents that structure in a machine-readable form. ASTs are often used as inputs to algorithms that perform optimization or other mathematical operations on formulas.

Referring back to FIG. 1A, the extracted input data are fetched from the input data from the database of input records 114, arranged in a canonical data structure, and provided to an optimization solver 116. The optimization problem is solved by the optimization solver 116. Specifically, the optimization solver 116 may solve the optimization problem by satisfying the decision objectives and the constraints, in the context, to generate a solution and provide the desired recommendation based on the solution. Further, the optimization solver 116 may optimize the objective contribution functions and the constraint contribution functions using an iterative approach based on metaheuristics of the optimization solver.

As is commonly known, an objective contribution function is a mathematical function that maps the values of decision variables to a scalar value that represents the quality of a solution. The objective contribution function is used to evaluate and compare the quality of different solutions to a decision problem. The goal of an optimization problem is to find the solution that maximizes or minimizes the objective contribution function, depending on the problem's objective.

A constraint contribution function is a function that maps the values of decision variables to a scalar value that represents the degree of satisfaction of a constraint. In decision optimization, constraints are conditions that must be satisfied for a solution to be considered feasible. A constraint contribution function is used to evaluate the degree of satisfaction of each constraint and to determine whether a solution violates any constraints. If a solution violates a constraint, its constraint contribution function returns a non-zero value that represents the degree of constraint violation.

The optimization solver 116 may apply the respective constraint contribution functions to the input data, aggregate the constraint contribution functions to an aggregated constraint contribution value, and compare the aggregated constraint contribution value to a pre-specified constraint contribution limit value. The input data from the database of input records 114 and the optimization solver 116 may be structurally and functionally independent of each other.

In an embodiment, the optimization solver 116 may use solver metaheuristics algorithms to solve optimization problems. Solver metaheuristics include higher-level strategies for solving optimization problems, as opposed to direct methods that solve the problem directly. Solver metaheuristics are typically used to find near-optimal solutions to complex and difficult optimization problems, such as those that are non-linear, multi-modal, or have many constraints. Solver metaheuristics are particularly useful for problems where the optimal solution is not easily found using traditional optimization methods. Examples of metaheuristics may include perturbation size, initial temperature, cooling rate and the like.

As is commonly known in decision optimization art, “perturbation size” is the number of selections or changes made at a time, per iteration of a solver. “Initial temperature” is a control variable that influences the amount of risk the solver takes in accepting less optimal solutions during an intermediate iteration. “Cooling rate” is the rate at which the initial temperature decreases over time to stabilize the solutions.

In a default or basic metaheuristic configuration, the selections available to a solver may be random selections. In another configuration, there may be an added flexibility such that the solver is capable of adding more selections at a later stage of optimization. In an instance, example selections that may be made during the iterations may include a selection of the specific data records that may be modified, a selection of the decision variables that may be modified, and a selection of the respective values of the decision variables. Several analytical methods may be used to interpret the relationships within the data records and thereby, to improve the selections during the iterations.

Further, in order to determine a suitable metaheuristic for an optimization problem, trial and error experiments may be carried out with “mini-solvers” and the results from the mini-solver experiments may be compared and scaled up to arrive at solver-level statistics. The mini-solvers typically use a smaller number of iterations, fewer samples of data, and/or other similar ways to determine, in a shorter time, the likely behavior of the solutions at the selected metaheuristic values. An example solver technique may be “simulated annealing”, which uses temperature as a metaheuristic.

In an embodiment, the solver metaheuristics used by the optimization solver 116 may include a simulated annealing algorithm that is inspired by the process of annealing in materials science. This algorithm typically uses a random search process that operates over an extended time frame and finds a near-optimal solution.

In an embodiment, the performance of the optimization solver 116 may be simplified using a set of simplification rules based on the mathematical formula of the AST structure being used. The simplification rules typically simplify the expressions the objectives and the constraints used in the AST expressions and their corresponding formula grammar. Provided below are some example applications of the simplification rules. For instance, to begin with, every node in an AST expression may be annotated with a boolean property such as “Static” or the like. Subsequently, the node may be processed in a command-specific way in accordance with the annotation and one or more of the simplification rules.

As a general practice, the simplification algorithm, in order to evaluate one of the AST expressions, may begin at a root node, recursively evaluate each child node below the root node, and then evaluate the root node based on the annotation of the children nodes. The simplification process may further involve moving the nodes around and/or adjusting parts of the optimization problem definition. The simplification process may be repeated recursively on the AST to result in a final AST that is either unchanged or smaller and faster to compute.

### Example 1

An example decision objective expression may be to maximize the expected sales amount expressed as a product of the total amount of sales (expressed as “Amount”) multiplied by predicted chance of win (expressed as “$Prediction.ChanceOfWin”). In other words, the decision objective is:
Maximizing: Amount*$Prediction.ChanceOfWin

FIG. 1B is a visual representation of an Abstract Syntax Tree structure 130 of the expression above. Referring to FIG. 1B, the simplification algorithm may begin at the root node (*) 132 and attempt to interpret if the node is annotated as “static” or not. In order to interpret as above, the simplification algorithm may traverse the children nodes “Amount” 134 and “$Prediction.ChanceOfWin” 136 and follow their respective annotations, if any. In this case, traversing from left to right, it may be found that the first child node, “Amount” 134, is not annotated as static. Further, the second child node, “Prediction” 136 is also not annotated as static. Following one of the predefined simplification rules that states that if either child is not static, the root node is not static, the simplification algorithm concludes that no further simplification is possible and the simplification algorithm stops.

### Example 2

An example decision objective expression may be to maximize the total sales amount, expressed in thousands of dollars. In other words, the decision objective is:
Maximizing: (Amount/1000)

FIG. 1C is a visual representation of an Abstract Syntax Tree structure 140 of the expression above. Referring to FIG. 1C, beginning at the root node 142 and traversing the children “Amount” 144 and “1000” 146 below, from left to right, it may be found that the first child node, “Amount” 144, is not annotated as static. The second child node, “1000” 146, however, is a numerical constant and therefore, static. The simplification algorithm, in this case, may follow one of the simplification rules that states when one child is static, the root node may be replaced with the non-static node and the constraint (limit) value may be divided by the numerical value of the static node. From hereon, the simplification process may proceed in the way mentioned above.

### Example 3

An example decision objective expression may be to maximize the total expected sales (expressed as “$Prediction.ChanceOfWin*Amount) less a conditional loss factor (expressed as “IF($Company.TracksAverageLoss, $Company.HistoricAverageLoss, 0)”). In other words,
Maximize: $Prediction. ChanceOfWin*Amount−IF($Company.TracksAverageLoss, $Company.HistoricAverageLoss, 0).

FIG. 1D is a first visual representation of an Abstract Syntax Tree structure 150 of the expression above. FIG. 1E is a second visual representation of an Abstract Syntax Tree structure 160 of the expression above, after annotation. Referring to FIG. 1E, beginning at the root node 162 and traversing the children 164 and 166 below, from left to right, it may be found that the subtrahend node (the node on the right) 166 is static. The simplification algorithm, in this case, may follow one of the simplification rules that states that when a subtrahend node is static, it may be removed and replaced with the minuend node (the node on the left) 164. The simplification rule may further state that when the minuend node is static and the subtrahend node is not, then the formula may be replaced with the number at the right, with the sense (positive or negative) of the decision objective reversed. In other words, a minimizing objective may become a maximizing one and vice versa.

In this case, the original expression may be simplified as:
Amount*$Prediction.ChanceOfWin.

From hereon, the simplification process may proceed in the way mentioned above.

### Example 4

An example decision constraint function, IF (Service=‘Premium’, 1, 0)*50 with a limit of 1,000 may mean that there are only 1,000 units available for premium service and each opportunity consumes 50. FIG. 1F is an initial visual representation of an Abstract Syntax Tree structure 170 of the decision constraint function optimization expression above. FIG. 1G is a second visual representation of an Abstract Syntax Tree structure 180 of the expression above, after annotating all static nodes with a tick or the like. Referring to FIG. 1G, beginning at the root node 182 and traversing the children 184 and 186 below, from left to right, it may be found that one child node 186 is static. The simplification algorithm, in this case, may follow one of the simplification rules that states that a root node may be replaced with a non-static child node and the constraint (limit) value may be divided by the static node. FIG. 1H is a third visual representation of a simplified Abstract Syntax Tree structure 190 of the expression above, with a new limit of 20 (1000 divided by 50).

From hereon, the simplification process may proceed in the way mentioned above.

Referring back to FIG. 1A, the optimization solutions generated and simplified by the optimization solver 116 may be stored in an optimization solution storage 118. The stored solutions may be accessed directly in real time or at a different time during a solution consumption stage. Further, the solutions may be paired to corresponding individual instance of data and applied to the corresponding individual instances of data, as needed. For instance, a first example application 122 may use one of the optimization solutions stored in the optimization solution storage 118 to optimize the appearance of several user interface components. A second example application 124 may use an optimization solution stored in the optimization solution storage 118 to optimize the performance of a price prediction application programming interface (API). A third example application 126 may use an optimization solution stored in the optimization solution storage 118 to optimize the performance of a customer relationship management (CRM) application.

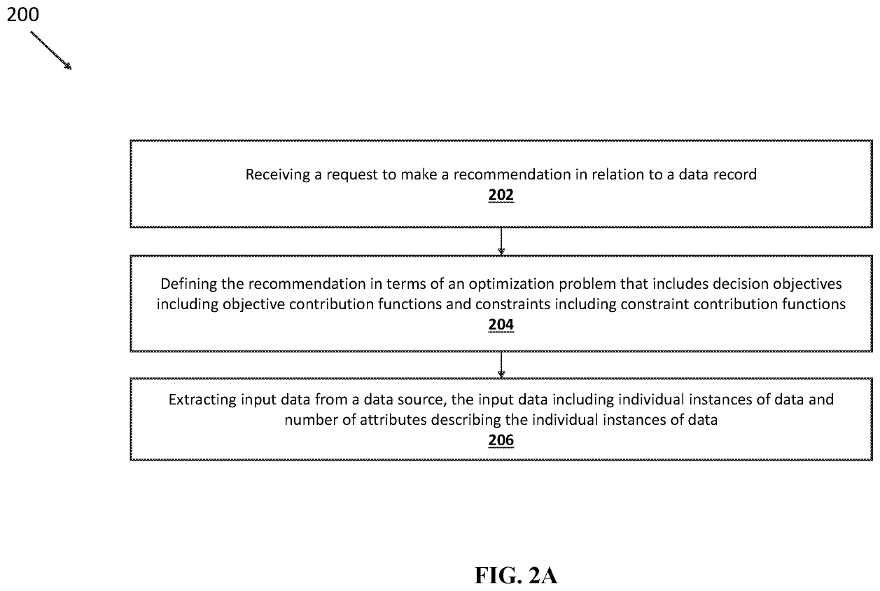

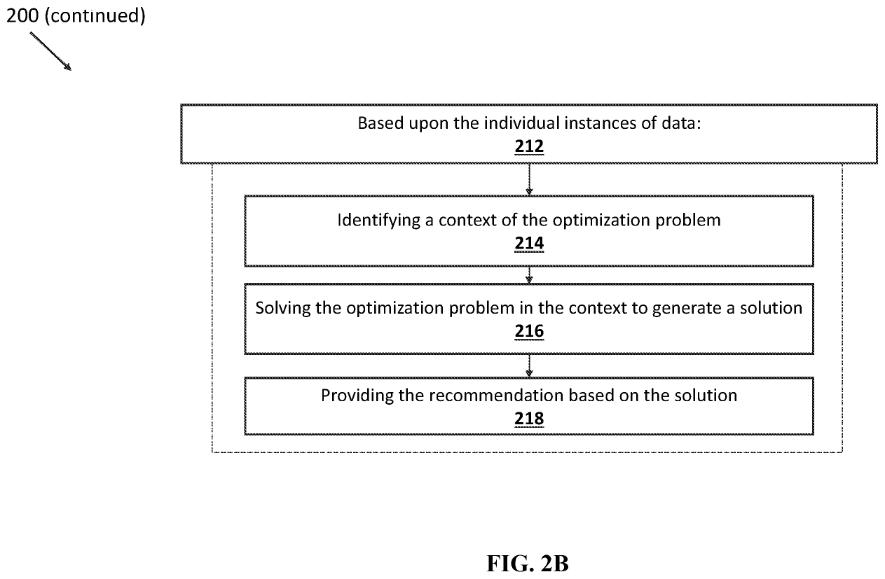

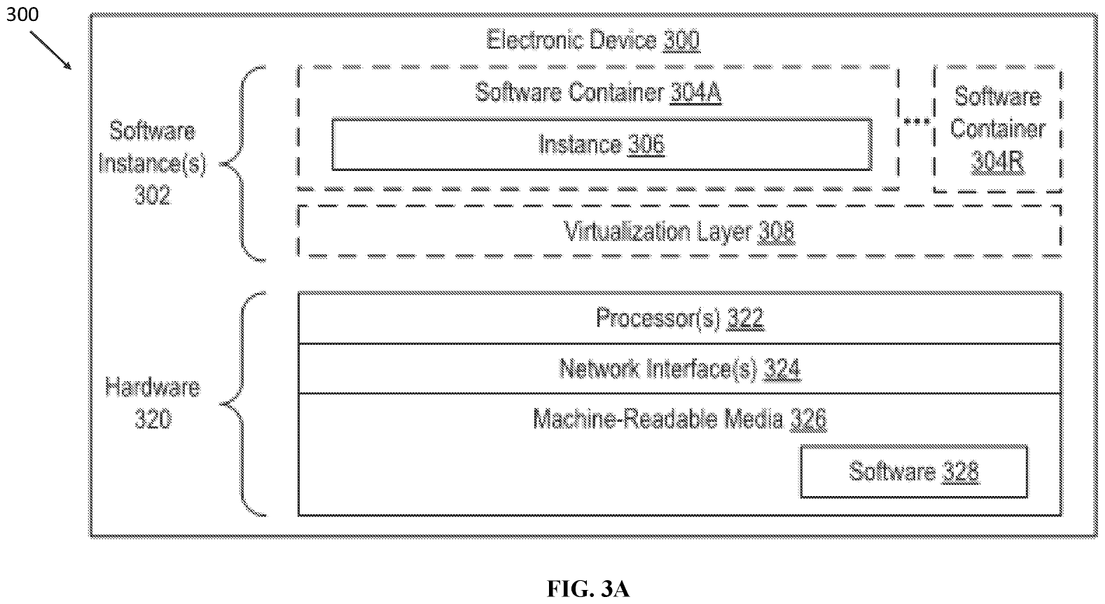

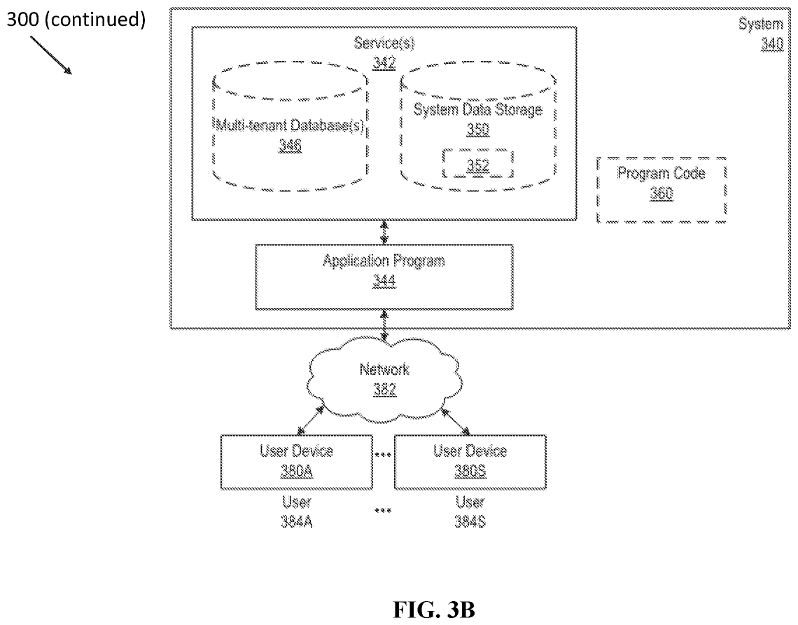

FIG. 2A is a flow diagram illustrating a computer-implemented method 200 for decision optimization in a multi-record environment, as disclosed herein. The method 200 may be performed, for example, by a system as shown in FIG. 1A operating in conjunction with the hardware as shown in FIGS. 3A and 3B and/or by software executing on a server or distributed computing platform. Although the steps of method 200 are presented in a particular order, this is only for simplicity.

The computer-implemented method 200 may include, as in step 202, receiving a request to make a recommendation in relation to a data record. At 204, the recommendation is defined in terms of an optimization problem. The optimization problem includes a number of decision objectives including objective contribution functions and a number of constraints including constraint contribution functions. At 206, input data is extracted from a data source. The input data includes a number of individual instances of data and a number of attributes describing the individual instances of data.

FIG. 2B is a flow diagram illustrating a computer-implemented method 200 for decision optimization in a multi-record environment, as disclosed herein. Based upon the plurality of individual instances of data, as in 212, a context of the optimization problem is identified, as in 214. The context may relate to a behavior of the input data given the decision objectives and the constraints. At 216, the optimization problem is solved by satisfying the decision objectives and the constraints, in the context, to generate a solution. At 218, the recommendation is provided based on the solution.

One or more parts of the above implementations may include software. Software is a general term whose meaning may range from part of the code and/or metadata of a single computer program to the entirety of multiple programs. A computer program (also referred to as a program) includes code and optionally data. Code (sometimes referred to as computer program code or program code) includes software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM). Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices may transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program: an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices: examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (typically, though not necessarily an individual person) that uses an electronic device. Software and/or services may use credentials to distinguish different accounts associated with the same and/or different users. Users may have one or more roles, such as administrator, programmer/developer, and end user roles. As an administrator, a user typically uses electronic devices to administer them for other users, and thus an administrator often works directly and/or indirectly with server devices and client devices. The term “consumer” refers to another computer service that is running the reusable software components of the system o FIG. 1A.

FIG. 3A is a block diagram illustrating an electronic device 300 according to some example implementations. FIG. 3A includes hardware 320 including a set of one or more processor(s) 322, a set of one or more network interfaces 324 (wireless and/or wired), and machine-readable media 326 having stored therein software 328 (which includes instructions executable by the set of one or more processor(s) 322). The machine-readable media 326 may include non-transitory and/or transitory machine-readable media. Each of the previously described clients and server components may be implemented in one or more electronic devices 300. In one implementation: 1) each of the clients is implemented in a separate one of the electronic devices 300 (e.g., in end user devices where the software 328 represents the software to implement clients to interface directly and/or indirectly with server components (e.g., software 328 represents a web browser, a native client, a portal, a command-line interface, and/or an application programming interface (API) based upon protocols such as Simple Object Access Protocol (SOAP), Representational State Transfer (REST), etc.)): 2) server components is implemented in a separate set of one or more of the electronic devices 300 (e.g., a set of one or more server devices where the software 328 represents the software to implement the framework for providing additional security to protected fields in protected views); and 3) in operation, the electronic devices implementing the clients and server components may be communicatively coupled (e.g., by a network) and may establish between them (or through one or more other layers and/or other services) connections for submitting requests to server components and returning responses to the clients. Other configurations of electronic devices may be used in other implementations (e.g., an implementation in which the client and server components are implemented on a single one of electronic device 300).

During operation, an instance of the software 328 (illustrated as instance 306 and referred to as a software instance; and in the more specific case of an application, as an application instance) is executed. In electronic devices that use compute virtualization, the set of one or more processor(s) 322 typically execute software to instantiate a virtualization layer 308 and one or more software container(s) 304A-304R (e.g., with operating system-level virtualization, the virtualization layer 308 may represent a container engine (such as Docker Engine by Docker, Inc. or rkt in Container Linux by Red Hat, Inc.) running on top of (or integrated into) an operating system, and it allows for the creation of multiple software containers 304A-304R (representing separate user space instances and also called virtualization engines, virtual private servers, or jails) that may each be used to execute a set of one or more applications: with full virtualization, the virtualization layer 308 represents a hypervisor (sometimes referred to as a virtual machine monitor (VMM)) or a hypervisor executing on top of a host operating system, and the software containers 304A-304R each represent a tightly isolated form of a software container called a virtual machine that is run by the hypervisor and may include a guest operating system: with para-virtualization, an operating system and/or application running with a virtual machine may be aware of the presence of virtualization for optimization purposes). Again, in electronic devices where compute virtualization is used, during operation, an instance of the software 328 is executed within the software container 304A on the virtualization layer 308. In electronic devices where compute virtualization is not used, the instance 306 on top of a host operating system is executed on the “bare metal” electronic device 300. The instantiation of the instance 306, as well as the virtualization layer 308 and software containers 304A-304R if implemented, are collectively referred to as software instance(s) 302.

Alternative implementations of an electronic device may have numerous variations from that described above. For example, customized hardware and/or accelerators might also be used in an electronic device.

FIG. 3B is a block diagram of a deployment environment according to some example implementations. A system 340 includes hardware (e.g., a set of one or more server devices) and software to provide service(s) 342, including server components. In some implementations the system 340 is in one or more datacenter(s). These datacenter(s) may be: 1) first party datacenter(s), which are datacenter(s) owned and/or operated by the same entity that provides and/or operates some or all of the software that provides the service(s) 342; and/or 2) third-party datacenter(s), which are datacenter(s) owned and/or operated by one or more different entities than the entity that provides the service(s) 342 (e.g., the different entities may host some or all of the software provided and/or operated by the entity that provides the service(s) 342). For example, third-party datacenters may be owned and/or operated by entities providing public cloud services.

The system 340 is coupled to user devices 380A-380S over a network 382. The service(s) 342 may be on-demand services that are made available to one or more of the users 384A-384S working for one or more entities other than the entity which owns and/or operates the on-demand services (those users sometimes referred to as outside users) so that those entities need not be concerned with building and/or maintaining a system, but instead may make use of the service(s) 342 when needed (e.g., when needed by the users 384A-384S). The service(s) 342 may communicate with each other and/or with one or more of the user devices 380A-380S via one or more APIs (e.g., a REST API). In some implementations, the user devices 380A-380S are operated by users 384A-384S, and each may be operated as a client device and/or a server device. In some implementations, one or more of the user devices 380A-380S are separate ones of the electronic device 300 or include one or more features of the electronic device 300.

In some implementations, the system 340 is any generic network interface management system that uses web interfaces and includes server application components, client application components and a browser extension. The system and method provide for authenticating the end user via a browser extension that needs to be available in the intended user's web browser. The input to the system and method is the information about the views and its specific fields or any other part that is rendered and need to be protected, as provided by the application owner. Typical generic examples are Java clients and applications. Python based frameworks, libraries for client applications implementing the logic described above.

In some implementations, the system 340 is any generic network interface management system that uses web interfaces and includes server application components, client application components and a browser extension. The system and method provide for authenticating the end user via a browser extension that needs to be available in the intended user's web browser. The input to the system and method is the information about the views and its specific fields or any other part that is rendered and need to be protected, as provided by the application owner. Typical generic examples are Java clients and applications. Python based frameworks, libraries for client applications implementing the logic described above.

Network 382 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4th generation wireless protocol (4G) (e.g., the Long Term Evolution (LTE) standard. LTE Advanced. LTE Advanced Pro), a fifth generation wireless protocol (5G), and/or similar wired and/or wireless protocols, and may include one or more intermediary devices for routing data between the system 340 and the user devices 380A-380S.

Each user device 380A-380S (such as a desktop personal computer, workstation, laptop. Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 340. For example, the user interface device may be used to access data and applications hosted by system 340, and to perform searches on stored data, and otherwise allow one or more of users 384A-384S to interact with various GUI pages that may be presented to the one or more of users 384A-384S. User devices 380A-380S might communicate with system 340 using TCP/IP (Transfer Control Protocol and Internet Protocol) and, at a higher network level, use other networking protocols to communicate, such as Hypertext Transfer Protocol (HTTP). File Transfer Protocol (FTP). Andrew File System (AFS). Wireless Application Protocol (WAP). Network File System (NFS), an application program interface (API) based upon protocols such as Simple Object Access Protocol (SOAP). Representational State Transfer (REST), etc. In an example where HTTP is used, one or more user devices 380A-380S might include an HTTP client, commonly referred to as a “browser.” for sending and receiving HTTP messages to and from server(s) of system 340, thus allowing users 384A-384S of the user devices 380A-380S to access, process and view information pages and applications available to it from system 340 over network 382.

In the above description, numerous specific details such as resource partitioning/sharing/duplication implementations, types and interrelationships of system components, and logic partitioning/integration choices are set forth in order to provide a more thorough understanding. Embodiments disclosed herein may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation.” “an implementation.” “an example implementation.” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art may know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is illustrative and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and may be practiced with modification and alteration within the spirit and scope of the appended claims. The description is thus illustrative instead of limiting.

What is claimed is:

1. A computer implemented method for decision optimization in a multi-record environment, the method comprising:
receiving a request to make a recommendation in relation to a data record;
defining the recommendation in terms of an optimization problem comprising a plurality of decision objectives comprising objective contribution functions and a plurality of constraints comprising constraint contribution functions;
extracting input data from a data source, the input data comprising a plurality of individual instances of data and a plurality of attributes describing the individual instances of data;
based upon the plurality of individual instances of data, identifying a context of the optimization problem, the context relating to a behavior of the input data given the decision objectives and the constraints;
solving the optimization problem by satisfying the plurality of decision objectives and the plurality of constraints, in the context, to generate a solution; and
providing the recommendation based on the solution.

2. The method of claim 1, wherein the satisfying the plurality of constraints comprises:
applying the respective constraint contribution functions to the input data;
aggregating the constraint contribution functions to an aggregated constraint contribution value; and
comparing the aggregated constraint contribution value to a pre-specified constraint contribution limit value.

3. The method of claim 2, wherein the extracting the input data comprises:
fetching the input data from the data source;
arranging the input data in a canonical data structure; and
providing the input data, arranged in the canonical data structure, to an optimization solver, wherein the optimization problem is solved by the optimization solver.

4. The method of claim 3, wherein the input data and the optimization solver are independent of each other.

5. The method of claim 3, wherein the optimization solver optimizes the objective contribution functions and the constraint contribution functions using an iterative approach based on metaheuristics of the optimization solver.

6. The method of claim 3 further comprising storing the solution, wherein the solution is accessed directly in real time or at a different time during a solution consumption stage.

7. The method of claim 6, further comprising:
pairing the solution to a corresponding individual instance of data; and
applying the solution to the corresponding individual instance of data.

8. The method of claim 1, wherein the input data comprises dynamic data with a dynamic context, the dynamic context having a nonpredetermined behavior.

9. The method of claim 8, wherein the dynamic context is configured to populate an abstract syntax tree structure conforming to a corresponding formula grammar.

10. The method of claim 9, wherein a performance of the abstract syntax tree structure is optimized using an optimization strategy based on a mathematical formula of the abstract syntax tree structure.

11. A system for decision optimization in a multi-record environment, the system comprising:
a computer processor;
a server application digitally connected with the computer processor, the server application comprising:
a decision optimization model configured to receive a request to make a recommendation and generate a recommendation based on the request;
a non-transitory machine-readable storage medium that provides instructions that, if executed by the processor, are configurable to cause the system to perform operations comprising:
receiving the request to make the recommendation in relation to a data record;
defining the recommendation in terms of an optimization problem comprising a plurality of decision objectives comprising objective contribution functions and a plurality of constraints comprising constraint contribution functions;
extracting input data from a data source, the input data comprising a plurality of individual instances of data and a plurality of attributes describing the individual instances of data;
based upon the plurality of individual instances of data, identifying a context of the optimization problem, the context relating to a behavior of the input data given the decision objectives and the constraints;
solving the optimization problem by satisfying the plurality of decision objectives and the plurality of constraints, in the context, to generate a solution; and
providing the recommendation based on the solution.

12. The system of claim 11, wherein the satisfying the plurality of constraints comprises:
applying the respective constraint contribution functions to the input data;
aggregating the constraint contribution functions to an aggregated constraint contribution value; and
comparing the aggregated constraint contribution value to a pre-specified constraint contribution limit value.

13. The system of claim 12, wherein extracting the input data comprises:
fetching the input data from the data source;
arranging the input data in a canonical data structure; and
providing the input data, arranged in the canonical data structure, to an optimization solver, wherein the optimization problem is solved by the optimization solver.

14. The system of claim 13, wherein the optimization solver optimizes the objective contribution functions and the constraint contribution functions using an iterative approach based on metaheuristics of the optimization solver.

15. The system of claim 11, wherein the input data comprises dynamic data with a dynamic context, the dynamic context having a nonpredetermined behavior.

16. The system of claim 15, wherein the dynamic context is configured to populate an abstract syntax tree structure conforming to a corresponding formula grammar.

17. The system of claim 16, wherein a performance of the abstract syntax tree structure is optimized using an optimization strategy based on a mathematical formula of the abstract syntax tree structure.

18. A non-transitory machine-readable storage medium that provides instructions that, if executed by a processor, are configurable to cause said processor to perform operations comprising:
receiving a request to make a recommendation in relation to a data record;
defining the recommendation in terms of an optimization problem comprising a plurality of decision objectives comprising objective contribution functions and a plurality of constraints comprising constraint contribution functions;
extracting input data from a data source, the input data comprising a plurality of individual instances of data and a plurality of attributes describing the individual instances of data;
based upon the plurality of individual instances of data, identifying a context of the optimization problem, the context relating to a behavior of the input data given the decision objectives and the constraints;
solving the optimization problem by satisfying the plurality of decision objectives and the plurality of constraints, in the context, to generate a solution; and
providing the recommendation based on the solution.

19. The non-transitory machine-readable storage medium of claim 18, wherein the satisfying the plurality of constraints comprises:
applying the respective constraint contribution functions to the input data;
aggregating the constraint contribution functions to an aggregated constraint contribution value; and
comparing the aggregated constraint contribution value to a pre-specified constraint contribution limit value.

20. The non-transitory machine-readable storage medium of claim 19, wherein extracting the input data comprises:
fetching the input data from the data source;
arranging the input data in a canonical data structure; and
providing the input data, arranged in the canonical data structure, to an optimization solver, wherein the optimization problem is solved by the optimization solver.

21. The non-transitory machine-readable storage medium of claim 20, wherein the optimization solver optimizes the objective contribution functions and the constraint contribution functions using an iterative approach based on metaheuristics of the optimization solver.

22. The non-transitory machine-readable storage medium of claim 21, further comprising:
pairing the solution to a corresponding individual instance of data; and
applying the solution to the corresponding individual instance of data.

23. The non-transitory machine-readable storage medium of claim 21, wherein the input data comprises dynamic data with a dynamic context, the dynamic context having a nonpredetermined behavior.

24. The non-transitory machine-readable storage medium of claim 23, wherein the dynamic context is configured to populate an abstract syntax tree structure conforming to a corresponding formula grammar.

25. The non-transitory machine-readable storage medium of claim 24, wherein a performance of the abstract syntax tree structure is optimized using an optimization strategy based on a mathematical formula of the abstract syntax tree structure.
